(19) United States
(12) Patent Application Publication
(10) Pub. No.: US 2002/0132751 A1
(43) Pub. Date: Sep. 19, 2002

(54) Detergent compositions

(75) Inventors: Reinhard Kohlus, Vlaardingen (NL); Harmannus Tammes, Vlaardingen (NL); Michel Jan De Ruijter, Vlaardingen (NL); Rahul Dominic Vas Bhat, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/025,239

(22) Filed: Dec. 19, 2001

(30) Foreign Application Priority Data
Dec. 22, 2000 (EP) 00311678.7

(51) Int. Cl. C11D 17/00

(52) U.S. Cl. 510/445; 510/447; 510/456

(57) ABSTRACT

A detergent tablet of compacted particulate composition comprising organic surfactant, detergency builder and optionally other ingredients, wherein the tablet or a region thereof comprises; i) particles which comprise surfactant mixed with other material, and ii) other particles which accelerate tablet disintegration on contact with water, wherein there is a deposit of water-soluble material on the exterior of at least some of the surfactant-containing particles i) and further wherein the particles i) further comprise detergency builder and the particles ii) comprise water-insoluble particles which are able to swell on contact with water, or, further wherein the water-soluble material is present as particles which have a smaller particle size than the particles i). This deposit further accelerates tablet disintegration on contact with water.

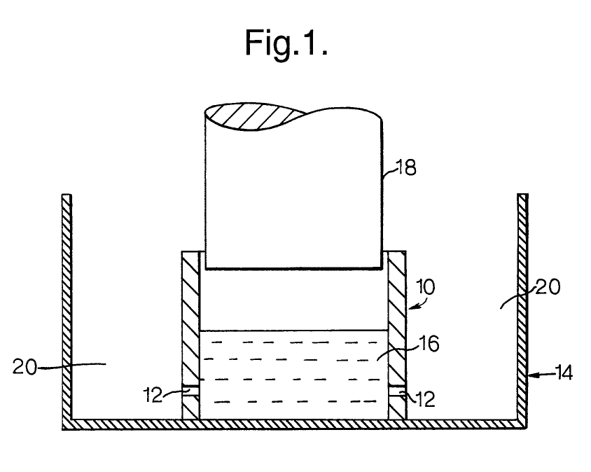

### FIELD OF THE INVENTION

This invention relates to detergent compositions in the form of tablets, especially tablets for use in fabric washing.

### BACKGROUND OF THE INVENTION

Detergent tablets have the advantage that they do not require the user to measure out a volume of powder or liquid. Instead one or several tablets provide an appropriate quantity of composition for washing a single load in a washing machine or possibly by hand. They are thus easier for the consumer to handle and dispense.

Detergent compositions in tablet form have been described in numerous patent documents and are sold commercially.

Such tablets are generally made by compressing or compacting a quantity of detergent composition in particulate form. Although it is desirable that tablets have adequate strength when dry, yet disperse and dissolve quickly when brought into contact with water, it can be difficult to obtain both properties together. Tablets formed using a low compaction pressure tend to crumble and disintegrate on handling and packing; while more forcefully compacted tablets may be sufficiently cohesive but then fail to disintegrate or disperse to an adequate extent in the wash. Tableting will often be carried out with enough pressure to achieve a compromise between these desirable but antagonistic properties. However, it remains desirable to improve one or other of these properties without detriment to the other so as to improve the overall compromise between them. Thus, if the speed of disintegration can be improved without reducing the strength, the manufacturer may choose to compact the particulate composition more forcefully and thereby make stronger tablets which disintegrate at the same speed as before.

In such tablets organic surfactant is present and functions as a binder, plasticising the tablet. However, it can also retard disintegration and dissolution of a tablet. As a tablet is wetted, organic detergent can form viscous gel phases which retard penetration of water into the tablet interior. A number of expedients have been proposed for the purpose of increasing speed of disintegration of tablets without merely sacrificing strength.

For instance, EP-A-466484 (Unilever) discusses the size of particles which are compacted into tablets. It teaches that the particles should be uniform in size and that fine particles are to be avoided.

A number of additive materials have been found to increase the speed of disintegration of tablets. EP-A-839906 (Unilever) teaches that the speed of disintegration of tablets can be accelerated by incorporating the organic detergent into a base powder and then admixing particles of a specified form of sodium tripolyphosphate. This sodium tripolyphosphate is present as just over 30% wt of the tablet.

EP-A-711827 and EP-A-838519 (both Unilever) teach that the speed of disintegration of tablets with water-insoluble non-phosphorus builder can be accelerated by including a highly water soluble salt. Organic surfactant was incorporated within a granulated base powder. In EP-A-838519 one example of base powder contained 20% wt anionic detergent and 15% wt nonionic detergent.

Another form of additive which is effective to increase the speed of disintegration of detergent tablets is particulate material which swells on contact with water. Such materials are referred to in WO 98/40463 (Henkel) and WO 00/44870 (Unilever).

U.S. Pat. No. 3,231,505 discloses detergent tablets which are made from a particulate detergent composition which has a coating of soluble silicate applied to the particulate detergent composition before it is compacted into tablets.

EP-A-1 088 884 (published Apr. 4, 2001) discloses detergent tablets made from anionic surfactant granules which are coated with relatively high levels of water soluble salts. The detergent tablets also comprise a water swellable disintegrant material.

EP-A-711 827 discloses detergent tablets comprising particles coated with a binder material such as polyethylene glycol or polyacrylates.

U.S. Pat. No. 4,642,197 discloses a powdery activator for percompounds granulated with nitrogen containing compounds and optionally a water soluble salt of a polyphosphonic acid. The granulate is mixed with disintegrant granules and tabletted.

### SUMMARY OF THE INVENTION

The present invention provides detergent tablets of compacted particulate composition containing organic surfactant, detergency builder and optionally other ingredients, characterised by a deposit of water-soluble material on the exterior of at least some of the surfactant-containing particles. This deposit may be present as particles which have a smaller particle size than the surfactant-containing particles or it may be present on particles which comprise surfactant and detergency builder and which are mixed with particles of a water insoluble but water swellable disintegrant.

We have found that the combination of strength and speed of disintegration achievable with such tablets can, in accordance with this invention, be enhanced by providing a surface deposit of water soluble material, as herein described, on at least some of the surfactant-containing particles.

More specifically, we have found that it is possible to achieve an increase in the speed of disintegration of tablets which already include a particulate constituent which enhances speed of disintegration.

In a first aspect, the invention provides a detergent tablet of compacted particulate composition comprising organic surfactant, detergency builder and optionally other ingredients, wherein the tablet or a discrete region thereof comprises;

i) particles which comprise surfactant mixed with other material, and

ii) other particles which accelerate tablet disintegration on contact with water,

wherein the surfactant-containing particles i) further comprise detergency builder, the disintegration-accelerating particles ii) comprise water-insoluble particles which are able to swell on contact with water, and there is a deposit of water-soluble material on the exterior of at least some of the surfactant-containing particles i).

According to a second aspect there is provided a detergent tablet of compacted particulate composition comprising organic surfactant, detergency builder and optionally other ingredients, wherein the tablet or a discrete region thereof comprises;

i) particles which comprise surfactant mixed with other material, and

ii) other particles which accelerate tablet disintegration on contact with water,

wherein there is a deposit of water-soluble material on the exterior of at least some of the surfactant-containing particles i), and the water-soluble material is present as particles which have a smaller particle size than the surfactant-containing particles i).

The particles (ii) which accelerate disintegration will generally be such that a test tablet consisting of the particles (i) and the other particles (ii) disintegrates faster than a test tablet of equal strength consisting of the particles (i) alone above.

Organic surfactant is preferably concentrated in the particles (i). Thus it may be preferred that at least 80% wt of the organic surfactant is contained within the particles (i) which constitute no more than 70% wt or even 60% wt of the tablet or region thereof. Alternatively at least 90 or 95% wt, or all, of the organic surfactant in the composition of the tablet or region is contained within particles (i) which constitute no more than 90% wt of the tablet or region. A deposit of water-soluble material is provided according to the invention on the exterior of at least some of these surfactant-containing particles.

Preferably the composition of a tablet or region thereof comprises 20 to 80% or 90% by weight of particles which comprise organic surfactant mixed with other material and preferably including detergency builder, while other particles present are, or include, 3 to 60% by weight of the composition of disintegration-accelerating particles (ii). The composition may include a balance of further material.

In a third aspect this invention provides a process for preparing a tablet of compacted detergent composition comprising organic surfactant, detergency builder and optionally other ingredients, the process comprising the steps of;

1) preparing particles i) which comprise organic surfactant mixed with other material comprising detergency builder;

2) depositing a water-soluble material on the exterior of at least some of the surfactant-containing particles i),

3) mixing these particles i) with other particles ii) which accelerate tablet disintegration on contact with water and which comprise water-insoluble particles which are able to swell on contact with water,

and then compacting the composition into a tablet or region of a tablet.

In a fourth aspect this invention provides a process for preparing a tablet of compacted detergent composition comprising organic surfactant, detergency builder and optionally other ingredients, the process comprising the steps of;

1) preparing particles i) which comprise organic surfactant mixed with other material;

2) depositing a water-soluble material on the exterior of at least some of the surfactant-containing particles i), the material being present as particles which have a smaller particle size than the surfactant-containing particles i);

3) mixing these particles i) with other particles ii) which accelerate tablet disintegration on contact with water,

and then compacting the composition into a tablet or region of a tablet.

The material which is deposited on the surfactant-containing particles (i) may conveniently be a water-soluble salt. Other possibilities are nonionic compounds, for example mono and disaccharides. Molecular weight of a non-ionic compound or an ionic salt should be below 1000, preferably below 500.

The solubility of the deposited water soluble material may be at least 5 g or log per 10 g of water at 20° C. The material is generally solid at temperatures up to at least 30° C. so that it remains on the surface of the particles.

The particles (i) may suitably be a detergent composition base powder to which is added post-dosed ingredients.

Without being bound by theory, we believe that such material reduces the hydrophobic bonding between surfactant-containing particles when the composition is compacted. Surprisingly the result is an overall improvement in properties even though another expedient (other particles (ii)) to enhance disintegration is also being employed.

According to the first aspect of the invention, the deposit of water-soluble material may consist of particles of that material, adhered to the exterior of the surfactant-containing particles (i), in which case the particles of this deposit suitably have smaller particle size than the detergent-containing particles.

According to the first and second aspects of the invention, the particles of water-soluble material may have a mean particle size which is not more than one third of the mean particle size of the surfactant-containing particles, for example a mean particle size which is from one tenth to one fifth or one third of the mean particle size of the surfactant-containing particles.

Another possibility is that the deposit of water-soluble material may be provided as a partial or complete coating on the surfactant-containing particles (i), as will be described in more detail below.

The amount of water-soluble material deposited on the surface of surfactant-containing particles (i) is likely to be from 0.1% to 15% by weight of the particles on which it is deposited and from 0.05% to 10% by weight of the overall composition, of the tablet or region thereof.

It is principally envisaged that tablets of this invention will be used for machine washing of fabrics. However, it is not ruled out that the invention could be utilised in tablets for other purposes, such as machine dishwashing.

Detergent tablets may be either homogeneous or heterogeneous. In the present specification, the term “homogeneous” is used to mean a tablet produced by compaction of a single particulate composition, but does not imply that all the particles of that composition will necessarily be of identical composition. The term “heterogeneous” is used to mean a tablet consisting of a plurality of discrete regions, for example layers, inserts or coatings, each derived by compaction from a particulate composition. In a heterogeneous tablet, each discrete region of the tablet will preferably constitute at least 10% wt of the overall weight of the tablet.

Except in the operating and comparative examples, or where otherwise explicitly indicated, all numbers in this description indicating amounts of material or conditions of reaction, physical properties of materials and/or use are to be understood as modified by the word “about.” All amounts are by weight, unless otherwise specified.

Materials and Further Details

Materials which may be used in tablets of this invention, will now be discussed in more detail, along with preferred and optional features of the invention.

Surfactant-containing Particles

The organic surfactant in the particles (i) will come from one or more of the categories of surfactant used in surfactant compositions for fabric washing. These are most usually anionic and nonionic surfactants and mixtures of the two. Amphoteric and (less commonly) cationic surfactants can also be used.

We prefer that the particles (i) contain a mixture of anionic and nonionic surfactants. Another possibility is to use more than one kind of surfactant-containing particles, such as particles with a formulation containing anionic surfactant and a second set of particles containing nonionic surfactant.

Anionic Surfactant Compounds

Synthetic (i.e. non-soap) anionic surfactants are well known to those skilled in the art. The anionic surfactant may comprise, wholly or predominantly, linear alkyl benzene sulphonate of the formula;

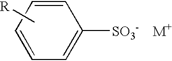

where R is linear alkyl of 8 to 15 carbon atoms and M⁺ is a solubilising cation, especially sodium.

Primary alkyl sulphate having the formula;

ROSO₃⁻M⁺

in which R is an alkyl or alkenyl chain of 8 to 18 carbon atoms especially 10 to 14 carbon atoms and M⁺ is a solubilising cation, is also commercially significant as an anionic surfactant and may be used in this invention.

Frequently, such linear alkyl benzene sulphonate or primary alkyl sulphate of the formula above, or a mixture thereof, will be the desired non-soap anionic surfactant and may provide 75 to 100 wt % of any anionic non-soap surfactant in the composition.

Examples of other non-soap anionic surfactants include olefin sulphonates; alkane sulphonates; dialkyl sulphosuccinates; and fatty acid ester sulphonates.

One or more soaps of fatty acids may also be included in addition to the required non-soap anionic surfactant. Examples are sodium soaps derived from the fatty acids from coconut oil, beef tallow, sunflower or hardened rapeseed oil. These may be formed by adding fatty acid and a base such as sodium carbonate to a slurry which is spray-dried to form the surfactant-rich base particles.

Nonionic Surfactant Compounds

Nonionic surfactant compounds include in particular the reaction products of compounds having a hydrophobic group and a reactive hydrogen atom, for example, aliphatic alcohols, acids, amides or alkyl phenols with alkylene oxides, especially ethylene oxide.

Specific nonionic surfactant compounds are alkyl (C₈₋₂₂) phenolethylene oxide condensates, the condensation products of linear or branched aliphatic C₈₋₂₀ primary or secondary alcohols with ethylene oxide, and products made by condensation of ethylene oxide with the reaction products of propylene oxide and ethylene-diamine.

Especially preferred are the primary and secondary alcohol ethoxylates, especially the C₉₋₁₁ and C₁₂₋₁₅ primary and secondary alcohols ethoxylated with an average of from 3 to 20 moles of ethylene oxide per mole of alcohol.

Amphoteric Surfactants

Amphoteric surfactants which may be used jointly with anionic or nonionic surfactants or both include amphopropionates of the formula:

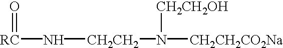

where RCO is a acyl group of 8 to 18 carbon atoms, especially coconut acyl.

The category of amphoteric surfactants also includes amine oxides and also zwitterionic surfactants, notably betaines of the general formula;

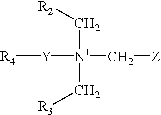

where R₄ is an aliphatic hydrocarbon chain which contains 7 to 17 carbon atoms, R₂ and R₃ are independently hydrogen, alkyl of 1 to 4 carbon atoms or hydroxyalkyl of 1 to 4 carbon atoms such as CH₂OH, Y is CH₂ or of the form CONHCH₂CH₂CH₂ (amidopropyl betaine); Z is either a COO⁻ (carboxybetaine), or of the form CHOHCH₂SO₃—(sulfobetaine or hydroxy sultaine).

Another example of amphoteric surfactant is amine oxide of the formula;

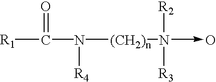

where R₁ is C₁₀ to C₂₀ alkyl or alkenyl; R₂, R₃ and R₄ are each hydrogen or C₁ to C₄ alkyl, while n is from 1 to 5.

Cationic surfactants may possibly be used. These frequently have a quaternised nitrogen atom in a polar head group and an attached hydrocarbon group of sufficient length to be hydrophobic. A general formula for one category of cationic surfactants is;

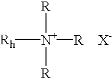

where each R independently denotes an alkyl group or hydroxyalkyl group of 1 to 3 carbon atoms and Rₕ denotes an aromatic, aliphatic or mixed aromatic and aliphatic group of 6 to 24 carbon atoms, preferably an alkyl or alkenyl group of 8 to 22 carbon atoms and X⁻ is a counterion.

Detergency Builders

Tablets of this invention contain water-soluble or water-insoluble detergency builder. According to the first aspect of the invention, and preferably according to the second aspect of the invention, at least some of it is included in the surfactant-containing particles (i).

Water-soluble phosphorus-containing inorganic detergency builders include the sodium and potassium orthophosphates, metaphosphates, pyrophosphates and polyphosphates.

Alkali metal aluminosilicates are strongly favoured as environmentally acceptable water-insoluble builders for fabric washing. Alkali metal (preferably sodium) aluminosilicates may be either crystalline or amorphous or mixtures thereof, having the general formula:

0.8-1.5Na₂O.Al₂O₃.0.8-6SiO_{2.}xH₂O

These materials contain some bound water (indicated as “xH₂O”) and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature.

Suitable crystalline sodium aluminosilicate ion-exchange detergency builders are described, for example, in GB 1429143 (Procter & Gamble). The preferred sodium aluminosilicates of this type are the well known commercially available zeolites A and X and the novel zeolite P described and claimed in EP 384070 (Unilever) which is also referred to as zeolite MAP and mixtures thereof. Zeolite MAP is available from Ineos Silicas, UK: an alternative designation is zeolite A24.

Conceivably, water-insoluble detergency builder could be a crystalline layered sodium silicate as described in U.S. Pat. No. 4,664,839.

NaSKS-6 is the trademark for a crystalline layered silicate marketed by Hoechst (commonly abbreviated as “SKS-6”). NaSKS-6 has the delta-Na₂SiO₅ morphology form of layered silicate. It can be prepared by methods such as described in DE-A-3,417,649 and DE-A-3,742,043. Other such layered silicates, which can be used have the general formula NaMSiₓO₂ₓ₊₁.yH₂O wherein M is sodium or hydrogen, x is a number from 1.9 to 4, preferably 2, and y is a number from 0 to 20, preferably 0.

Non-phosphorous water-soluble builders may be organic or inorganic. Inorganic builders that may be present include alkali metal (generally sodium) carbonate; while organic builders include polycarboxylate polymers, such as polyacrylates and acrylic/maleic copolymers, monomeric polycarboxylates such as citrates, gluconates, oxydisuccinates, glycerol mono- di- and trisuccinates, carboxymethyloxysuccinates, carboxymethyloxymalonates, dipicolinates and hydroxyethyliminodiacetates.

Tablet compositions preferably include polycarboxylate polymers, more especially polyacrylates and acrylic/maleic copolymers which can function as builders and also inhibit unwanted deposition onto fabric from the wash liquor.

Preparation of the Surfactant-containing Particles (i)

The surfactant-containing particles (i) may be made by a variety of methods. These may be conventional processes, such as spray drying and agglomeration. Processes for the production of particles by agglomeration using a high speed mixer followed by a moderate speed mixer have been described in U.S. Pat. No. 5,133,924, 5,164,108 and WO 98/11193 (all Unilever).

Both spray drying and agglomeration tend to produce particles in which the organic surfactant is not uniformly distributed throughout the particles but is concentrated towards the particle surface, which in consequence can be somewhat sticky.

Water-soluble particles of smaller particle size may be deposited on the surface of spray-dried or agglomerated surfactant-containing particles by mixing them together in a low-speed mixer.

Some published processes for the manufacture of surfactant-containing particles by agglomeration require that a finely-divided material is added near to the end of the agglomeration process, in order to make the particles less sticky. Usually a finely-divided water-insoluble material is used, such as fine silica or aluminosilicate. However, such procedures can be adapted for making particles to be used in this invention, by replacing these finely divided insoluble particles with a finely divided water-soluble material.

If the surfactant-containing particles are spray dried, a coating of water soluble material could be applied by spraying a solution of the material into the spray-drying tower, part way down its height, so that it deposits on the surface of particles which have already formed in the drying tower, and is itself dried during the remainder of the descent down the tower.

Spray-dried surfactant-containing particles and agglomerated surfactant-containing particles i) containing water-insoluble detergency builder are especially preferred according to the invention.

Other techniques for application of a coating are known—for example an aqueous solution of a soluble material can be sprayed onto a fluidised bed of the particulate composition which is to be coated.

Proportions of Surfactant-containing Particles

Generally, a tablet or a region thereof made in accordance with this invention will comprise overall from 5 wt % or 8 wt % up to 40 or 50 wt % non-soap surfactant, and from 5 or 10 wt % up to 60 or 80 wt % detergency builder.

The percentage of non-soap anionic surfactant in the tablet or a region thereof will generally be at least equal to, preferably at least one and a half times, the percentage of nonionic surfactant. It is preferably from 3 wt % or 5 wt % up to 30 or 40 wt % of the tablet or region. The amount of nonionic surfactant is preferably from 2 to 15 wt % of the tablet or region thereof.

The quantity of soap in the tablet or region thereof is preferably from 0.1 or 0.2 up to 1% or 2% by weight of the tablet or region thereof. Higher proportions such as up to 4% wt are less preferred.

Where a tablet is heterogenous, these percentage ranges may apply to the overall composition of the tablet, and also to at least one region of the tablet.

Organic surfactant is preferably present in particles (i) which contain between 10% and 50% (by weight of these particles) of organic surfactant and between 40% or 50% and 90% (again by weight of these particles) of detergency builder. These particles may contain other materials, typically in amounts from 10% to 30% by weight of such particles.

As already indicated, these particles (i) preferably constitute from 20% to 70% or 80% by weight of the overall composition, more preferably from 35% up to 55 or 60% of the composition of the tablet or region. It is especially preferred that the composition comprises from 35% to 55% wt of the surfactant-containing particles i), and these particles comprise at least 90% wt of the organic surfactant in the composition.

Disintegration Accelerating Particles

The surfactant-containing particles (i) receive a water-soluble deposit on them, as will be explained further below, and are mixed with disintegration-accelerating particles (ii). These disintegration-accelerating particles may be water-soluble particles or water-swellable, water-insoluble particles according to the second aspect of the invention and comprise water-swellable, water-insoluble particles according to the first aspect. Of course, in the second aspect of the invention be water-soluble disintegration-accelerating particles may also be present.

The composition preferably comprises 3 to 60% by weight of disintegration-accelerating particles ii).

Water-soluble accelerating particles (ii) preferably consist of (or contain more than half their own weight of) water-soluble material selected from either:

compounds, especially salts, with a water-solubility exceeding 50 g/100 g in water at 20° C.; or

phase I sodium tripolyphosphate,

sodium tripolyphosphate which is partially hydrated so as to contain water of hydration in an amount which is at least 0.5% by weight of the sodium tripolyphosphate in the particles.

Sodium tripolyphosphate containing at least 50% of its own weight of the Phase I anhydrous form, and which is partially hydrated so as to contain water of hydration in an amount which is at least 1% by weight of the sodium tripolyphosphate in the particles is especially preferred.

Preferably the water-soluble disintegration particles (ii) comprise at least 80% (by weight of these particles) of one or more of the above mentioned materials.

As will be explained further below, these disintegration-accelerating particles can also contain other forms of tripolyphosphate or other salts within the balance of their composition.

If the material in such water-soluble disintegration-accelerating particles can function as a detergency builder, (as is the case with sodium tripolyphosphate) then of course it contributes to the total quantity of detergency builder in the tablet composition.

If water-soluble disintegration-accelerating particles are present in a tablet or region thereof, the amount may be from 3 or 5% wt upwards by weight of the tablet or region thereof. The quantity may possibly be from 8 to 12% up to 15, 25 or 30% wt or more. If the material has a second function (as is the case with sodium tripolyphosphate) it may be used in amounts up to 60% by weight of the tablet or region.

A solubility of at least 50 grams per 100 grams of water at 20° C. is an exceptionally high solubility: many materials which are classified as water soluble are less soluble than this.

Some highly water-soluble salts which may be used are listed below, with their solubilities expressed as grams of solid to form a saturated solution in 100 grams of water at 20° C.:

| Material | Water Solubility (g/100 g) |
|---|---|
| Sodium citrate dihydrate | 72 |
| Potassium carbonate | 112 |
| Sodium acetate, anhydrous | 119 |
| Sodium acetate trihydrate | 76 |
| Magnesium sulphate 7H₂O | 71 |
| Potassium acetate | >200 |

By contrast the solubilities at 20° C. of some other common
materials are:-

| Material | Water Solubility (g/100 g) |
|---|---|
| Sodium chloride | 36 |
| Sodium sulphate decahydrate | 21.5 |
| Sodium carbonate anhydrous | 8.0 |
| Sodium percarbonate anhydrous | 12 |
| Sodium perborate anhydrous | 3.7 |
| Sodium tripolyphosphate anhydrous | 15 |

Preferably this highly water soluble material is incorporated as particles of the material in a substantially pure form (i.e. each such particle contains over 95% by weight of the material). However, the said particles may contain material of such solubility in a mixture with other material, provided that material of the specified solubility provides at least 50% by weight of these particles, better at least 80% wt.

Another possibility is that the said particles which promote disintegration are particles comprising sodium tripolyphosphate with more than 50% thereof (by weight of the particles) in the anhydrous phase I form.

Sodium tripolyphosphate is very well known as a sequestering builder in surfactant compositions. It exists in a hydrated form and two crystalline anhydrous forms. These are the normal crystalline anhydrous form, known as phase II which is the low temperature form, and phase I which is stable at high temperature. The conversion of phase II to phase I proceeds fairly rapidly on heating above the transition temperature, which is about 420° C., but the reverse reaction is slow. Consequently phase I sodium tripolyphosphate is metastable at ambient temperature.

A process for the manufacture of particles containing a high proportion of the phase I form of sodium tripolyphosphate by spray drying below 420° C. is given in U.S. Pat. No. 4,536,377.

Particles which contain this phase I form will often contain the phase I form of sodium tripolyphosphate as at least 55% by weight of the tripolyphosphate in the particles. Other forms of sodium tripolyphosphate will usually be present to a lesser extent. Other salts may be included in the particles, although that is not preferred.

Desirably, this sodium tripolyphosphate is partially hydrated. The extent of hydration should be at least 1% by weight of the sodium tripolyphosphate in the particles. It may lie in a range from 2.5 to 4% wt, or it may be higher, e.g. up to 8% wt.

Suitable material is commercially available. Suppliers include Rhone-Poulenc, France and Rhodia, UK. “Rhodiaphos HPA 3.5” from Rhone-Poulenc has been found to be particularly suitable. It is a characteristic of this grade of sodium tripolyphosphate that it hydrates very rapidly in a standard O1ten test. We have found that it hydrates as quickly as anhydrous sodium tripolyphosphate, yet the prehydration appears to be beneficial in avoiding unwanted crystallisation of the hexahydrate when the material comes into contact with water at the time of use.

Particles comprising highly soluble salt or particles containing the special form of sodium tripolyphosphate described above preferably contain 80% by weight of the salt concerned, probably at least 90% wt. More preferably they consist of such salt in a purity of at least 95% by weight.

Water-Swellable Material

The disintegration-accelerating particles ii) comprise water-insoluble particles which are able to swell on contact with water instead of, or in addition to, the water soluble disintegrant-accelerating materials referred to above in the first aspect of the invention. Such materials may be present according to the second aspect of the invention.

A number of water-insoluble, water-swellable materials are known to be useful as tablet disintegrants, in particular for pharmaceutical tablets. A discussion of such materials is found in “Drug Development and Industrial Pharmacy”, Volume 6, pages 511-536 (1980).

In tablets of the invention such materials may be used as, or within, disintegration-accelerating particles (ii) in an amount of 0.1% or 0.5% up to 10% by weight of the tablet or discrete region thereof. Such materials may be mixed with each other, or mixed with other materials as carriers. Water-swellable disintegrant particles may be used in amounts from 0.1 or 0.5% up to 10% by weight of the composition of the tablet or region thereof.

Suppliers of water-swellable disintegrant materials include J Rettenmaier & Söhne in Germany and FMC Corporation in USA.

Such swelling materials are mostly polymeric in nature and many of them are of natural origin. Such disintegrants include starches, for example, maize, rice and potato starches and starch derivatives, such as Primojel™ or Explotab™, both of which are sodium starch glycolate also known as sodium carboxymethyl starch; celluloses, for example Arbocel®-B and Arbocel®-BC (beech cellulose), Arbocel®-BE (beech-sulphite cellulose), Arbocel®-B-SCH (cotton cellulose), Arbocel®-FIC (pine cellulose) as well as further Arbocel® types from Rettenmaier and cellulose derivatives, for example Courlose™ and Nymcel™, sodium carboxymethyl cellulose, Ac-di-Sol™ cross-linked modified cellulose, microcrystalline cellulosic fibres and cross-linked cellulose; and various synthetic organic polymers.

Cellulose-containing fibrous materials originating from timber may be compacted wood pulps. So-called mechanical pulps generally incorporate lignin as well as cellulose whereas chemical pulps generally contain cellulose but little of the original lignin remains. Pulp obtained by a mixture of chemical and mechanical methods may retain some but not all of the original lignin. Cellulose based materials include Nylin LX-16 which is a water-insoluble compacted cellulose based disintegrant, commercially available from FMC Corporation.

Disintegrant particles may comprise a water-absorbent carrier material which may swell on initial contact with water, mixed with a minor proportion of another material which swells more strongly than the carrier material on contact with water. It may take up more water than the carrier material, or swell more rapidly or both. The proportions may be from 75% wt or 90% wt up to 99.9% wt of the carrier material and from 0.1 up to 10% wt, of the more strongly swelling material. Other material may be included to make up any balance.

Suitable disintegrant particles comprise water-swellable, water-insoluble material which is able to swell to at least twice its volume on contact with water, mixed with a water-absorbent carrier material which does not swell to as much as twice its volume on contact with water. These particles may be used in amounts of 0.5 to 10% by weight based on the tablet or region thereof.

An apparatus for measuring increase in volume is illustrated in “The Mechanisms of Disintegrant Action”. Kanic & Rudnic, Pharmaceutical Technology, April 1984, pages 50-63. This article also refers to papers describing other apparatus.

Another parameter which characterises swellable materials is the force which they exert if they are allowed to take up water whilst confined within an enclosure.

We have found that materials and particles which swell on contact with water are effective as disintegrants if there is a rapid development of force when they come into contact with water.

We have carried out measurements using a relatively simple piece of apparatus shown in the attached drawing and an Instron materials testing machine.

The apparatus consists of a cylinder (10) with internal diameter 25 mm and a length of 20 mm. This cylinder is perforated by a ring of holes (12) adjacent one end. There are 36 of these holes, of 1 mm diameter, with centres 2.5 mm from the end of the cylinder. This end of the cylinder is glued to the base of a glass container (14) of internal diameter 73 mm.

To test a sample of powdered disintegrant, 1.5 gram of the disintegrant is placed in the cylinder and gently tapped so that it forms a level bed (16) which is usually 6 mm to 10 mm deep depending on the bulk density of the powder.

A plunger (18) of the Instron machine is moved into the upper set of the cylinder, over this powder bed. Under computer control of the Instron machine the plunger is applied to the top of the powder bed (16) with a force of 1 Newton.

50 ml of distilled water at 22° C. is tipped into the annular space (20) around the cylinder. This water passes through the holes (12) into the powder bed. The Instron machine is programmed to hold the plunger in position against the swelling bed of powder, and the force required for this is recorded.

It is preferred that a strongly swelling material, if tested, by itself, has ability to absorb at least twice its own volume of water and has a development of expansion force which exceeds 1.5 Newton/second.

The development of swelling force has also been measured for a number of materials by C. Caramella et al published in International Journal of Pharmaceutical Technology and Production Manufacturing Volume 5 (2) pages 1 to 5, 1984, as set out in the following table;

| | | Disintegrating |
|---|---|---|
| | | force |
| Disintegrant | | development |
| Trade Name | Identity and supplier | rate (N/sec) |
| | Maize starch | 1.1 |
| Explotab ™ | Na-carboxy methyl starch | 2.0 |
| | ex. Mendell Co | |
| Primojel ™ | Na-carboxy methyl starch | 2.2 |
| | ex Avebe | |
| Avicel ™ PH | Micro crystalline | 0.6 |
| 101 | cellulose ex. FMC | |
| L-HPC ™ | Low substituted hydroxy | 2.2 |
| | propyl cellulose ex. | |
| | Shin-Etsu Japan | |
| Ac-di-Sol ™ | Cross-linked SCMC ex FMC | 3.5 |
| Polyplasdone ™ | Cross-linked PVP ex. ISP | 4.3 |
| XL | | |
| Aartberlite ™ | K-salt of methacrylic | 5.0 |
| IR 88 | acid cross-linked with | |
| | divinylbenzene ex. Robin | |
| | & Haas | |
| Plas-Vita ™ | Co-polymer of formalin | 3.1 |
| | and casein ex. | |
| | Eigenmann-Veronelli | |

The significant parameter is the maximum slope of a graph of expansion force against time.

Measurement of swelling can be recorded with the same apparatus as referred to above. The plunger is again applied to the top of a bed of the dry powder, and pressed against it with a force of 1 Newton. 50 ml of water is poured in as before. The Instron machine is programmed to allow expansion of the bed of powder, while maintaining a force on it of 1 Newton. Displacement of the plunger is recorded.

A strongly swelling material may come from a category referred to as a super-disintegrant. Such super disintegrants tend to be cross-linked synthetic or natural polymers and include cross-linked forms of carboxymethyl cellulose, cellulose, starch, polyvinylpyrrolidone and polyacrylate. The carrier materials are preferably selected from compounds which contain hydroxy groups. A carrier material may itself be a water-insoluble, and somewhat water-swellable, material. Such materials include starches, for example, maize, rice and potato starches, celluloses, microcrystalline cellulosic fibres and some synthetic organic polymers. Disintegrant particles may also contain up to 15% or 20% by weight of a water-soluble polymer which acts as a binder, e.g. polyethylene glycol.

Specifically, a super-disintegrant may take up more than twice and possibly more than 2.5 or 3 times its own volume of water, and/or develop expansion force exceeding 1.5 Newton/second while a carrier for it takes up less water by volume than the super-disintegrant and develops less expansion force.

The disintegrant particles may be made by mixing the swellable disintegrant with the carrier material, then compacting the mixture, and if necessary comminuting the compacted mixture into disintegrant particles. Preferably these have a particle size in a range from 250 to 1000 microns.

Mixing of these materials can be carried out by standard apparatus for mixing particulate solids. Other ingredients can be incorporated at this stage. If a polymeric binder is incorporated, it can be added in particulate form during this mixing operation. Alternatively, if it can be melted, the molten polymer can be sprayed on to the mixture or on to one particulate ingredient of the mixture.

Compaction of the mixture can be brought about by forcing it between a pair of rollers using any suitable operating conditions. One suitable apparatus, a roller compactor, has a feed screw which delivers the mixture to the nip of the rollers. The speed of the feed screw, and hence the amount of material delivered to the nip of the rollers should be high enough to force an unbroken stream of material through the rollers, but not so high that the material is converted into a dough.

The sheet of material which issues from the rollers is next broken up and milled to the required particle size.

Manufacturers of both roller compactor and milling machinery include Hosokawa Bepex located at Heilbronn, Germany, Alexanderwerk located at Remschied, Germany and Fitzpatrick located at Elmhurst, USA.

Bleach

Other ingredients which may be mixed with the surfactant containing particles (i) and disintegration-accelerating particles (ii) may include a bleach system. This preferably comprises one or more peroxy bleach compounds, for example, inorganic persalts or organic peroxyacids, which may be employed in conjunction with activators to improve bleaching action at low wash temperatures. If any peroxygen compound is present, the amount is likely to lie in a range from 10 to 25% by weight of the tablet.

Preferred inorganic persalts are sodium perborate monohydrate and tetrahydrate, and sodium percarbonate. Bleach activators have been widely disclosed in the art. Preferred examples include peracetic acid precursors, for example tetraacetylethylene diamine (TAED), and perbenzoic acid precursors. The quaternary ammonium and phosphonium bleach activators disclosed in U.S. Pat. Nos. 4,751,015 and 4,818,426 (Lever Brothers Company) are also of interest. Another type of bleach activator which may be used, but which is not a bleach precursor, is a transition metal catalyst as disclosed in EP-A-458397, EP-A-458398 and EP-A-549272. A bleach system may also include a bleach stabiliser (heavy metal sequestrant) such as ethylenediamine tetramethylene phosphonate and diethylenetriamine pentamethylene phosphonate.

Bleach activator is usually present in an amount from 1 to 10% by weight of the tablet, possibly less in the case of a transition metal catalyst which may be used as 0.1% wt or more by weight of the tablet.

Other Ingredients

The detergent tablets of the invention may also comprise one of the detergency enzymes well known in the art for their ability to degrade various soils and stains and so aid in their removal. Suitable enzymes include the various proteases, cellulases, lipases, amylases, and mixtures thereof, which are designed to remove a variety of soils and stains from fabrics. Detergency enzymes are commonly employed in the form of granules or marumes, optionally with a protective coating, in amount of from about 0.1% to about 3.0% by weight of the tablet.

The detergent tablets of the invention may also comprise a fluorescer (optical brightener), for example, Tinopal (Trade Mark) DMS or Tinopal CBS available from Ciba-Geigy AG, Basel, Switzerland. Tinopal DMS is disodium 4,4′bis-(2-morpholino-4-anilino-s-triazin-6-ylamino stilbene disulphonate; and Tinopal CBS is disodium 2,2′-bis-(phenyl-styryl) disulphonate.

An antifoam material is advantageously included, especially if a surfactant tablet is primarily intended for use in front-loading drum-type automatic washing machines. Antifoam materials in granular form are described in EP 266863A (Unilever). Such antifoam granules typically comprise a mixture of silicone oil, petroleum jelly, hydrophobic silica and alkyl phosphate as antifoam active material, sorbed onto a porous absorbed water-soluble carbonate-based inorganic carrier material.

It may also be desirable that a detergent tablet of the invention includes an amount of an alkali metal silicate, particularly sodium ortho-, meta- or disilicate. The presence of such alkali metal silicates may be advantageous in providing protection against the corrosion of metal parts in washing machines, besides providing some detergency building. Preferably the surfactant-rich particles contain from 5 to 15% wt silicate by weight of the particles. This improves the strength and free flow of these particles prior to tableting.

Further ingredients which can optionally be employed in fabric washing surfactant tablet of the invention include anti-redeposition agents such as sodium carboxymethylcellulose, straight-chain polyvinyl pyrrolidone and the cellulose ethers such as methyl cellulose and ethyl hydroxyethyl cellulose, fabric-softening agents; heavy metal seguestrants such as EDTA; perfumes; and colorants or coloured speckles.

These various other ingredients may be present in the surfactant-rich particles or in the balance of the composition outside them. It is preferred that any bleach is contained in the balance of the composition outside the surfactant-rich particles.

Tableting

Tableting entails compaction of a particulate composition. A variety of tableting machinery is known, and can be used. Generally it will function by stamping a quantity of the particulate composition which is confined in a die.

The mould in which the tablet is formed may be provided by an aperture within a rigid structure and a pair of dies which can be urged into the aperture towards each other, thereby compacting the contents of the aperture. A tableting machine may have a rotary table defining a number of apertures each with a pair or associated dies which can be driven into an apertures. Each die may be provided with an elastomeric layer on its surface which contacts the tablet material, as taught in WO 98/46719 or WO 98/46720.

Tableting may be carried out at ambient temperature or at a temperature above ambient which may allow adequate strength to be achieved with less applied pressure during compaction. In order to carry out the tableting at a temperature which is above ambient, the particulate composition is preferably supplied to the tableting machinery at an elevated temperature.

This will of course supply heat to the tableting machinery, but the machinery may be heated in some other way also.

If any heat is supplied, it is envisaged that this will be supplied conventionally, such as by passing the particulate composition through an oven, rather than by any application of microwave energy.

The size of a tablet will suitably range from 10 to 160 grams, preferably from 15 to 60 g, depending on the conditions of intended use, and whether it represents a dose for an average load in a fabric washing or dishwashing machine or a fractional part of such a dose. The tablets may be of any shape. However, for ease of packaging they are preferably blocks of substantially uniform cross-section, such as cylinders or cuboids.

The overall density of a tablet for fabric washing preferably lies in a range from 1040 or 1050 g/litre preferably at least 1100 g/litre up to 1400 g/litre. The tablet density may well lie in a range up to no more than 1350 or even 1250 g/litre. The overall density of a tablet of some other cleaning composition, such as a tablet for machine dishwashing or as a bleaching additive, may range up to 1700 g/litre and will often lie in a range from 1300 to 1550 g/litre.

The invention will be further exemplified by the following examples. Further examples within the scope of the present invention will be apparent to the person skilled in the art.

### EXAMPLE 1

A detergent base powder was made by a known neutralisation and granulation process wherein a pumpable feedstock comprising alkyl benzene sulphonic acid was prepared and the acid was then partially neutralised in the feedstock with a neutralising agent. The feedstock was fed into a high-speed mixer/densifier and any partially neutralised alkyl benzene sulphonic in the feedstock was further neutralised and a granular detergent material formed. This granular detergent material was dried and cooled. The composition of the base powder is shown below:

| Ingredient | parts by weight |
|---|---|
| Sodium linear alkylbenzene | 20.8 |
| sulphonate | |
| nonionic surfactant (C₁₃₋₁₅ branched | 3.2 |
| fatty alcohol 3E0) | |
| nonionic surfactant (C₁₃₋₁₅ branched | 5.9 |
| fatty alcohol 7E0) | |
| Soap | 1.6 |
| zeolite A24 (Zeolite MAP ex Ineos | 46.5 |
| Silicas, UK) | |
| Sodium acetate trihydrate | 5.9 |
| Sodium carbonate | 6.9 |
| Linear sodium carboxymethyl | 0.9 |
| cellulose (SCMC) | |
| Moisture and impurities | 8.3 |

This base powder was sieved to obtain particles between 500 and 100 μm. It was then modified by coating with sodium alkaline silicate. The powder was put into a fluidised bed and silicate was sprayed on as a 22% wt aqueous alkaline silicate solution. Two levels of silicate solution were used, 2% and 3% by weight of the base powder to produce examples 1 and 2 according to the invention. As a comparison, base powder was also put into the fluid bed under the same conditions and for the same duration, but without being sprayed with silicate solution to produce comparative example A.

A number of further ingredients were added to these powders by dry-mixing (except the perfume, which was sprayed on) resulting in the following compositions:

| | Parts by | | |
|---|---|---|---|
| | weight | | |
| Ingredients | 1 | 2 | A |
| Base powder | 53.21 | 52.67 | 54.30 |
| Alkaline silicate solution | 1.09 | 1.63 | — |
| (22% wt silicate) | | | |
| Antifoam granule | 2.29 | 2.29 | 2.29 |
| Fluorescer on sodium | 1.58 | 1.58 | 1.58 |
| carbonate | | | |
| Sodium disilicate granules | 3.19 | 3.19 | 3.19 |
| tetraacetylethylene diamine | 6.46 | 6.46 | 6.46 |
| (TAED) granules | | | |
| Sodium percarbonate coated | 19.20 | 19.20 | 19.20 |
| Polyethylene glycol | 2.00 | 2.00 | 2.00 |
| (1500 molecular weight) | | | |
| Sodium acetate trihydrate | 4.54 | 4.54 | 4.54 |
| Arbocel ® disintegrant | 4.54 | 4.54 | 4.54 |
| granule (ex Rettenmaier, | | | |
| Germany) | | | |
| Minors | 2.90 | 2.90 | 2.90 |
| TOTAL | 101 | 101 | 101 |

The sodium acetate trihydrate and the cellulose disintegrant are both disintegration-accelerating particles. The former is highly water soluble. The latter swells on contact with water.

The compositions were compacted on a Kilian single punch tableting machine, to produce cylindrical tablets with weights between 36.5 and 37.5 g. Various compaction pressures were used, aiming to produce tablets of two different strengths from each composition. Because of the silicate coating on the base powder particles, the compaction pressures required for compositions 1 and 2 were considerably higher than required to make tablets of similar strength from composition A (which had no silicate coating on the base powder particles).

The speed of disintegration of the tablets was tested by means of a procedure in which a tablet was placed on a metal grid with holes of 1 cm by 1 cm and immersed in 1 litre of water at ambient temperature of 20° C. The time taken for the tablet to completely fall through the grid was measured.

Tablet strength was tested by a process in which a cylindrical tablet is compressed radially between the platens of a materials testing machine until the tablet fractures. At failure, the tablet cracks and the applied force needed to maintain the displacement of the platens drops. Measurement is discontinued when the applied force needed to maintain the displacement has dropped by 25% from is maximum value.

The maximum force is the force at failure (F_{f}). From this measurement of force a test parameter called diametral fracture stress, was calculated using the equation;

$$σ = \frac{2 {F}_{f}}{π Dt}$$

where σ is the diametral fracture stress in Pascals, F_{f} is the applied force in Newtons to cause fracture, D is the tablet diameter in metres and t is the tablet thickness in metres. Generally it is preferred that detergent tablets have DFS of 14 kPa, better at least 20 kPa.

The break energy is the area under the graph of force against displacement, up to the point of break. It is given by the equation:

$${E}_{b} = {\int }_{0}^{{x}_{f}} F ( x ) ⅆ x$$

where E_{b} is the break energy in joules,

x is the displacement in metres,

F is the applied force in Newtons at displacement x, and

x_{f} is the displacement at failure.

The values of DFS and disintegration times are set out in the following table:

| Composition | 1 | 2 | A |
|---|---|---|---|
| Lower value of | 19.4 | 19.4 | 20.3 |
| DFS (kPa) | | | |
| Disintegration | 19 | 23 | 42 |
| time (s) | | | |
| Higher DFS | 36.0 | 38.6 | 36.6 |
| (kPa) | | | |
| Disintegration | 43 | 62 | 68 |
| time (s) | | | |

It can be seen that silicate sprayed on to the powder in compositions 1 and 2 gave a considerable reduction in disintegration time relative to the comparative composition A with no corresponding loss of tablet strength. This advantage is greatest in composition 1, showing that low levels of silicate are sufficient to obtain the benefit for disintegration.

### EXAMPLE 2

Tablets for use in fabric washing were made, starting with granulated base powder of the following composition, made by mixing under high shear followed by densification under reduced shear in accordance with the procedure described in WO-A-98/11193.

| Ingredient | parts by weight |
|---|---|
| Sodium linear alkylbenzene | 9.61 |
| sulphonate | |
| nonionic surfactant (C₁₃₋₁₅ branched | 2.76 |
| fatty alcohol 7E0) | |
| nonionic surfactant (C₁₃₋₁₅ branched | 1.47 |
| fatty alcohol 3E0) | |
| Soap | 0.74 |
| zeolite A24 (Zeolite MAP ex Ineos | 21.49 |
| Silicas, UK) | |
| Sodium acetate trihydrate | 2.75 |
| Sodium carboxymethylcellulose | 0.42 |
| moisture | Balance to 45 |

This powder was then mixed with further ingredients as follows in a low shear mixer for 5-20 seconds:

| Ingredients | Parts by weight |
|---|---|
| Base powder | 45.0 |
| Acrylate/maleate 70/30 copolymer | 1.34 |
| TAED granules | 5.24 |
| Anti-foam granules | 1.8 |
| Fluorescer granules | 1.0 |
| Soil release polymer | 1.13 |
| Organic phosphonate sequestrant | 0.67 |
| Cellulosic disintegrant | 3.0 |
| TOTAL | 59.18 |

The following salts were then added to the formulation in the low shear mixer:

| | |
|---|---|
| Sodium percarbonate (coated) | 15.63 |
| Sodium silicate granules | 3.60 |
| Sodium acetate trihydrate | 23.29 |
| OVERALL TOTAL | 101.70 |

In this example of the invention, the above three salts were subjected to a preliminary step in which they were mixed and ground in an Eirich pan mixer used as a grinder to provide a content of fine particles as well as larger particles (bimodal particle size distribution). The fine particles adhered to the surfactant-containing particles while mixing with them in the low shear mixer.

As a comparison, the same salts were used without grinding, so that they contained substantially no fine particles.

The ground salts were present on the surfactant-containing particles as a deposit of small particles having a smaller particle size than the surfactant-containing particles.

40 g portions of each composition were compacted into cylindrical tablets of 44 mm diameter, using an Instron testing machine to compact the compositions between two dies within a cylindrical mould.

For the tablets made using unground salts the compaction force was 9-7 kN. For tablets made using ground salts, the force was raised to 16 kN.

The tablets were tested as in the previous example. Additionally, water conductivity was monitored as the tablets dissolved, and time (T₉₀) to reach 90% of final conductivity was noted. Results were as follows:

| | Ground salts | Unground salts |
|---|---|---|
| Compaction force (kN) | 16 | 9.7 |
| Fₘₐₓ (N) | 51.2 | 24.5 |
| DFS (kpa) | 33.5 | 15.9 |
| Break energy (mJ) | 11.8 | 5.0 |
| T₉₀ (s) | 86 | 86 |
| T_{d} (s) | 45 | 38 |

As can be seen, the tablets made with ground salts, embodying the invention, were made so as to be much stronger, yet disintegrated almost as quickly.

What is claimed is:

1. A detergent tablet of compacted particulate composition comprising organic surfactant, detergency builder and optionally other ingredients, wherein the tablet or a discrete region thereof comprises;
i) particles which comprise surfactant mixed with other material, and
ii) other particles which accelerate tablet disintegration on contact with water,
wherein the surfactant-containing particles i) further comprise detergency builder, the disintegration-accelerating particles ii) comprise water-insoluble particles which are able to swell on contact with water, and a deposit of water-soluble material is present on the exterior of at least some of the surfactant-containing particles i).

2. A detergent tablet of compacted particulate composition comprising organic surfactant, detergency builder and optionally other ingredients, wherein the tablet or a discrete region thereof comprises;
i) particles which comprise surfactant mixed with other material, and
ii) other particles which accelerate tablet disintegration on contact with water,
wherein a deposit of water-soluble material is present on the exterior of at least some of the surfactant-containing particles i) and the water-soluble material is present as particles which have a smaller particle size than the surfactant-containing particles i).

3. The tablet according to claim 1 wherein the tablet or discrete region thereof is compacted from a particulate composition in which at least about 80% wt of the surfactant in the composition of the tablet or region thereof is contained within the surfactant-containing particles i), which particles i) constitute no more than about 60% wt of composition, with the deposit of water-soluble material being present on the exterior of at least some of the surfactant-containing particles i).

4. The tablet according to claim 1 wherein the tablet or discrete region thereof is compacted from a particulate composition in which at least about 90% wt of the surfactant in the composition of the tablet or region thereof is contained within surfactant-containing particles i) which particles i) constitute no more than about 90% of the composition, with the deposit of water-soluble material being present on the exterior of at least some of the surfactant-containing particles i).

5. The tablet according to claim 1 wherein the water-soluble material is present as particles which have a mean particle size which is not more than one third of the mean particle size of the surfactant-containing particles.

6. The tablet according to claim 1 wherein the water-soluble material is a salt with solubility of at least 5 g per 100 g of water at 20° C.

7. The tablet according to claim 1 wherein the surfactant-containing particles i) are spray-dried particles.

8. The tablet according to claim 1 wherein the surfactant-containing particles i) are agglomerated particles further comprising water-insoluble detergency builder.

9. The tablet according to claim 1 wherein the composition comprises from about 35% to about 55% wt of the surfactant-containing particles i), and these particles comprise at least about 90% wt of the surfactant in the composition.

10. The tablet according to claim 1 wherein the composition comprises about 3% to about 60% by weight of the disintegration-accelerating particles ii).

11. The tablet according to claim 1 wherein the isintegration-accelerating particles ii) comprise water-soluble particles comprising at least about 80% (by weight of these particles) of one or more materials selected from the group consisting of;
compounds with water-solubility exceeding 50 grams per 100 grams water,
phase I sodium tripolyphosphate,
sodium tripolyphosphate which is partially hydrated so as to contain water of hydration in an amount which is at least about 0.5% by weight of the sodium tripolyphosphate in the particles.

12. The tablet according to claim 2 wherein the disintegration-accelerating particles ii) comprise water-insoluble particles which are able to swell on contact with water.

13. The tablet according to claim 1 wherein the composition of the tablet or region thereof comprises about 0.5 to about 10% by weight of disintegration-accelerating particles ii) which comprise water-swellable, water-insoluble material which is able to swell to at least twice its volume on contact with water, mixed with a water-absorbent carrier material which does not swell to as much as twice its volume on contact with water.

14. A process for preparing a tablet of compacted detergent composition comprising organic surfactant, detergency builder and optionally other ingredients, the process comprising the steps of;
1) preparing particles i) which comprise organic surfactant mixed with other material comprising detergency builder;
2) depositing a water-soluble material on the exterior of at least some of the surfactant-containing particles i),
3) mixing these surfactant-containing particles i) with other particles ii), which other particles ii) accelerate tablet disintegration on contact with water and which comprise water-insoluble particles which are able to swell on contact with water,
and then compacting the composition into a tablet or region of a tablet.

15. A process for preparing a tablet of compacted detergent composition comprising organic surfactant, detergency builder and optionally other ingredients, the process comprising the steps of;
1) preparing particles i) which comprise organic surfactant mixed with other material;
2) depositing a water-soluble material on the exterior of at least some of the surfactant-containing particles i), the material being present as particles which have a smaller particle size than the surfactant-containing particles i);
3) mixing these surfactant-containing particles i) with other particles ii), which other particles accelerate tablet disintegration on contact with water,
and then compacting the composition into a tablet or region of a tablet.
